(19) United States
(12) Patent Application Publication
(10) Pub. No.: US 2006/0291360 A1
(43) Pub. Date: Dec. 28, 2006

(54) Information recording and reproduction method and information recording and reproduction apparatus

(76) Inventors: Takeshi Maeda, Koganei (JP); Motoyasu Terao, Hinode (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/209,731

(22) Filed: Aug. 24, 2005

(30) Foreign Application Priority Data
Jun. 23, 2005 (JP) 2005-183660

(51) Int. Cl. G11B 7/00

(52) U.S. Cl. 369/53.23

(57) ABSTRACT

A recording and reproduction method utilized for multilayer optical disks, wherein a light source for the servo layer and a light source for the recording layer are modulated at different frequencies or made to irradiate by time division onto a multilayer optical disk formed from a combination of a plurality of recording layers and one servo layer, so that information from each layer can be separated by even just one optical sensor.

### CLAIM OF PRIORITY

The present application claims priority from Japanese application JP 2005-183660 filed on Jun. 23, 2005, the content of which is hereby incorporated by reference into this application.

### FIELD OF THE INVENTION

This invention relates to an information recording and reproduction method and information recording and reproduction apparatus for optical recording and reproduction of information on a recording medium.

### BACKGROUND OF THE INVENTION

Main features of the optical disk are the use of a semiconductor laser as a light source, the recording disk that is removable from the recording and reproduction apparatus, and that the cost per bit of recording medium is inexpensive. The optical disk should therefore preferably possess a high density and high transfer rate without sacrificing any of these advantages. To increase the recording capacity, the single recording layer of the prior art was increased to two and three layers and a currently a multilayer read-only type of optical disk of up to eight layers has been disclosed. In this disclosure one light source is utilized, and the irradiated light from the light source is focused by an objective lens, as a focus point positioned on an optional recording layer on a two-dimensional plane, the reflected light rays are focused onto a lens, and a pin-hole formed at that (light) convergence point, and only the light passing through the pin-hole is detected by the optical detector in what is called a confocal detection system that eliminates leakage (intermediate cross-talk) from other layers (non-patent document 1).

Another type of optical disk for multilayer recording of data has been disclosed. In this method, one servo layer is combined with multiple data recording layers. One light source each is provided for data recording and for the servo. The light irradiated from the servo light source forms a tiny light spot on the servo layer that constantly follows the track within the surface of the servo layer. The data recording light emitted from the light source, records information on multiple recording layers while maintaining a fixed geometric placement with the light spot formed on the servo layer. To reproduce (read) information from each layer, the data recording spot is moved in a perpendicular direction to the disk, and the above mentioned pin-hole removes leakage from other layers (patent document 1).

Moreover, the technology in non-patent document 2 evaluates in detail how to cope with intermediate cross-talk via the shape of the optical detector, and establishes conditions for utilizing optics, the layer distance (interlayer gap) and the shape of the optical detector to reduce crosstalk without utilizing a pinhole.

[Patent document 1] U.S. Pat. No. 6,540,397

[Non-patent document 1) “Proposal for Multi-Layer Blu-ray Disc Structure” Technical Digest of International Symposium on Optical Memory 2004, We-E-02

[Non-patent document 2] “Analyses of Signals from Dual-Layer Phase Change Optical Disks” Japan Journal of Applied Physics, Vol. 42, Part I, No.9A, pp. 5624-5633

### SUMMARY OF THE INVENTION

Utilizing a confocal optical system with a multilayer disk is difficult because the pinhole must possess a small size on the order of one micrometer in order to eliminate leakage (crosstalk) from adjacent layers. The reason is that the fluctuations of several micrometers occur in the position of the reflected light convergence point due movement of the objective lens from tracking, adjustment errors in the optical system, variations in the optical axis over elapsed time, etc. The pinhole position also varies due to environmental changes and mechanical changes over time in the support mechanism. Furthermore, multiple optical detectors are installed at positions separated from the convergence point of the reflected light in order to detect tracking error (deviation) signals and focus point (deviation) signals, the light intensity balance of light received from these optical detectors must be detected. The pinhole is therefore incapable of blocking light from other layers and so another method for separating light is required. If the gap between the layers is widened, then the reflected light from each layer can be separated and the intermediate crosstalk reduced even with optical detectors of a certain size. However, from hereon the recording (storage) capacity of the multilayer disk will be increased which makes narrowing the interlayer gap unavoidable and in that case the reflected light from each layer cannot be separated out. Therefore, a method is required that allows optical detectors possessing a limited size to receive the transmitted light and reflected light from each layer and extract only the information from the specified layer.

This invention therefore has the object of providing an information recording and reproduction method and information recording and reproduction apparatus for fulfilling the above described needs in multilayer disks.

To resolve the above mentioned problems this invention utilizes a rotation disk made up of a two-dimensional plane surface multiple stacked information recording layers, and emits light onto this disk from at least two light sources, and changes the optical characteristics of the emitted light according to the information, and records information selectively on each recording layer in states with different optical characteristics, and changes the optical characteristics of the light emitted from the light source during reproduction (read), and receives the reflected light or transmitted light from the multiple recording layers, and detects the change in optical characteristics occurring due to the optical interaction of the reflected light and information recorded on each of the recording layers in the reflected and transmitted light, and selectively reproduces (reads) information from the specified recording layer.

The information recording/reproduction method of this invention utilizing a multilayer optical disk formed by a combination of a first servo layer and multiple recording layers; is characterized in comprising: a process for irradiating a first laser beam that is intensity-modulated by a first frequency and a second laser beam that is intensity-modulated by a second frequency along the optical axis of one objective lens onto a multilayer optical disk, and respectively converging the light on different positions on the optical axis; and a process for optically detecting the first laser beam and the second laser beam mutually interacting with the multilayer optical disk; and a process for deriving the tracking error signal and the focus error signal from the signal component created by the first laser beam interacting with the servo layer, acquired by frequency separation of the optical detector output; and a process for controlling the objective lens position versus the multilayer optical disk by utilizing the tracking error signal and the focus error signal, and slave the first laser beam spot to the desired track on the servo layer; and a process for deriving the focus error signal of the second laser beam on the recording layer from the signal component caused by the second laser beam interacting with one of the multiple recording layers obtained by frequency separation of the optical detector output; and a process for aligning the focus point of the second laser beam spot on the recording layer by utilizing the focus error signal of the second laser beam.

The information recording/reproduction apparatus of this invention utilizing a multilayer optical disk formed from a combination of one servo layer and multiple recording layers, is characterized in comprising: a first laser source; and a second laser source; and a first oscillator for intensity-modulating the light flux (ray) from the first laser source with a first frequency; and a second oscillator for intensity-modulating the light flux from the second laser source with a second frequency; an optical system for combining the light flux from the first laser source and the light flux from the second laser source on one axis; and an objective lens for converging the combined light flux from the first laser source and the light flux from the second laser source on respectively different positions on the optical axis; and an actuator for driving the objective lens; and a optical detector including a focus error detector and a tracking error detector; and a first frequency filter for separating out the signal components as a factor in the laser beam intensity-modulated by a first frequency and interacting with the servo layer from the output of the optical detector; and a second frequency filter for separating out the signal components as a factor in the laser beam intensity-modulated by a second frequency and interacting with the servo layer from the output of the optical detector; and a first focus point alignment section for driving the actuator along the optical axis direction based on the focus error detector output separated out by the first frequency filter; and a tracking controller for driving the actuator in a direction perpendicular to the optical axis based on the tracking error detector output separated out by the first frequency filter; and a second focus point alignment section for driving the light flux spot from the second laser source along the optical axis direction based on the focus point detector output separated out by the second frequency filter.

The information recording/reproduction method of this invention is characterized in comprising: a process for irradiating a first laser beam, and second laser beam onto the multilayer disk along the optical axis of one objective lens, utilizing a multilayer optical disk formed from a combination of one servo layer and multiple recording layers, and converging the first laser beam and the second laser beam onto respectively different positions on the optical axis; and a process for detecting the first laser beam that interacted with the servo layer; and a process for generating a sample logic signal from the first laser detection output signal; and a process for alternately lighting the first laser beam and the second laser beam according to the sample logic signal; and a process for deriving the tracking error signal and the focus error signal from the servo layer in the period that the first laser beam is lit up; and a process for controlling the objective lens position versus the multilayer optical disk by utilizing the tracking error signal and the focus error signal, and slave the first laser beam spot to the desired track on the servo layer; and a process for detecting the second laser beam interacting with one among the multiple recording layers, during the period that the second laser beam is lit up, and deriving the focus error signal of the second laser beam versus the recording layer; and a process for aligning the focus point of the second laser beam spot on the recording layer by utilizing the focus error signal of the second laser beam.

The information recording/reproduction apparatus of this invention utilizing a multilayer optical disk formed from a combination of one servo layer and multiple recording layers, is characterized in comprising: a first laser source; and a second laser source; and an optical system for combining the light flux from the first laser source and the light flux from the second laser source on one axis; and an objective lens for converging the combined light flux from the first laser source and the light flux from the second laser source on respectively different positions on the optical axis; and an actuator for driving the objective lens; and a optical detector including a focus error detector and a tracking error detector; and a timing generator circuit for generating a timing signal for alternately lighting up the first laser source and the second laser source based on a signal indicating the total detected light intensity ; and a first focus point alignment section for driving the actuator along the optical axis direction based on the focus error detector output in the period that the first laser source is lit up; and a tracking controller for driving the actuator in a direction perpendicular to the optical axis based on the output of the tracking error detector in the period that the first laser source is lit up; and a second focus point alignment section for driving the light flux spot from the second laser source along the optical axis direction based on the focus point detector output in the period that the second laser source is lit up.

This invention is capable of detecting a signal from multiple recording layers on a multilayer optical disk by using an optical detector that utilizes two light spots.

### BRIEF DESCRIPTION OF THE DRAWINGS

FIG. 1 is a drawing showing the structure of the 3-dimensional recording and reproduction apparatus of this invention;

FIGS. 2A and 2B are drawings showing the structure of the multilayer optical disk of this invention;

FIGS. 3A and 3B are drawings showing the optical detection system for the multilayer disk;

FIGS. 4A and 4B are drawings for describing the principle of the embodiment of the method for recording and reproducing onto the multilayer optical disk of this invention;

FIG. 5 is a detailed block diagram of the embodiment of the recording/reproduction circuit for the multilayer optical disk of this invention;

FIG. 6 is a block diagram of the overall recording/reproduction circuit of this invention;

FIG. 7 is a pictorial view of the servo layer of the multilayer optical disk of this invention;

FIG. 8 is another pictorial view of the servo layer of the multilayer optical disk of this invention;

FIGS. 9A to 9D are drawings for describing the principle of another embodiment of the method for recording and reproducing onto the multilayer optical disk of this invention;

FIG. 10 is a drawing showing an example of the servo track formed on the servo layer;

FIG. 11 is a detailed block diagram of another embodiment of the recording/reproduction circuit for the multilayer optical disk of this invention; and

FIG. 12 is a block diagram of the overall recording/reproduction circuit.

### DETAILED DESCRIPTION OF THE PREFERRED EMBODIMENTS

The embodiments of this invention are described next while referring to the accompanying drawings.

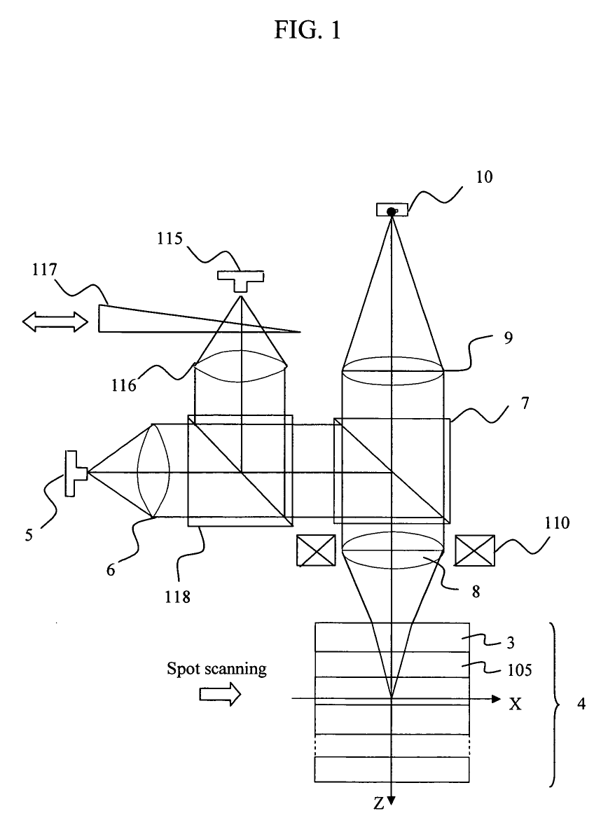

FIG. 1 is a drawing showing an example of the structure of the three-dimensional recording and reproduction apparatus of this invention. The received light optical system utilizes a reflected light detection system as an example however a transmitted (permeable) light detection system may be utilized. A multilayer optical disk 4 possesses a structure containing a recording layer 1 and an intermediate layer 2 alternately stacked in multiple layers on the transmittance (permeable) substrate. Information is recorded on the recording layer 1 by changing the optical characteristics at localized points by emitting light at localized points. The intermediate layer 2 is formed with the objective of augmenting the recording layer by anti-reflection, or preventing multi-reflection light absorption, and transfer printing of localized optical changes in the recording layer, or thermal insulation, and endothermy, or reinforcement. To record information, a light spot is focused on the desired recording layer on the multilayer disk 4, and the optical characteristics changed two-dimensionally on that recording layer and moreover changed independently of the other recording layers so that the recording corresponds to ones (“1”) and zeros (“0”) after modulation. Reproduction (read) is performed by detecting localized changes in the optical characteristics of the recording layer as changes in the reflected light intensity to reproduce the data by emitting the light spot onto the desired recording layer.

This optical system includes two light sources made up for example from a semiconductor laser 5 and a semiconductor laser 115. In the focusing optics system, the irradiated light emitted from the semiconductor laser 5 is converted to parallel light by a collimator 6 and irradiated onto the objective lens 8 by way of the polarized beam splitter 7. The reflected light from the disk 4 passes through the objective lens 8 and is guided by the beam splitter 7 into the receiving light image lens 9. The reflected light intensity is converted to electrical signals by the light detector 10 positioned in the vicinity of the lens 9 focus point.

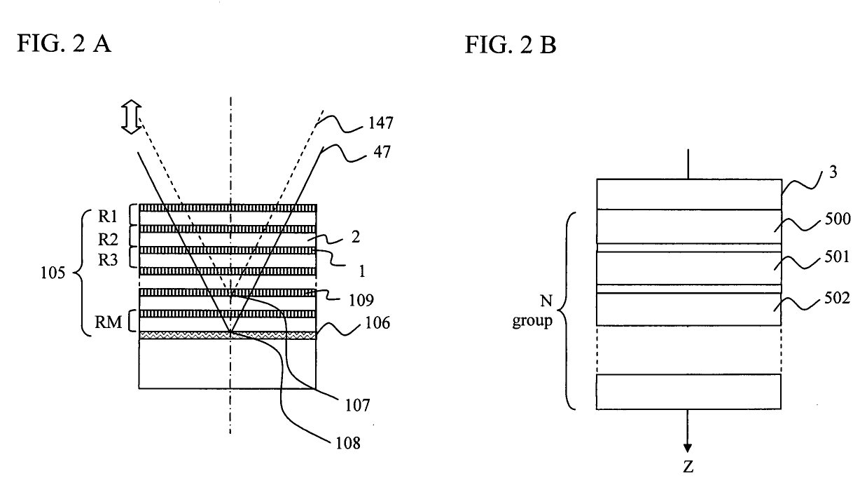

As shown in FIG. 2A, one servo layer 106 is formed every M layer of recording layers R1 through RM on the multilayer optical disk 4. The multilayer disk 4 can be made into a structure subdivided into N groups made up of multiple sets 500, 501, 502, as shown in FIG. 2B. The objective lens 8 converges the light flux from the semiconductor laser 5 onto the servo layer 106, forming tiny spots 108 on the layer. The objective lens (focusing lens) 8 converges the light flux 147 from the semiconductor laser 1 15 onto the recording layer 109 to forming tiny spots 107 on the layer. During recording and reproduction, the objective lens 8 is driven along the Z axis and positioned so that the spot 108 of the light flux 47 from the semiconductor laser 5 is always focused on the servo layer 106. There is a (guide) track described later, for guiding the spot 108 on the servo layer. The two-dimensional actuator 110 drives the objective lens 8 radially along the disk for tracking purposes. Therefore, the light flux 147 from the semiconductor laser 115 simultaneously irradiated onto the objective lens is driven, and the spot 107 is driven to follow the eccentricity of the disk synchronizing with the spot 108.

The light emitted from the semiconductor laser 5 becomes the light flux 47, and is utilized to read the information from the servo layer 106. The light emitted from the other semiconductor laser (115), passes through the wedge glass plate 117, become parallel light by the collimator lens 116, is bent on an optical path the direction of the polarized prism 7, by the combination prism 118, is combined with light emitted from the semiconductor laser 5, oriented towards the objective lens 8, and by adjusting the insert value of the wedge glass plate 117, is focused on the recording layer 109 serving as the one of the recording layers of M layers in a set with the servo layer.

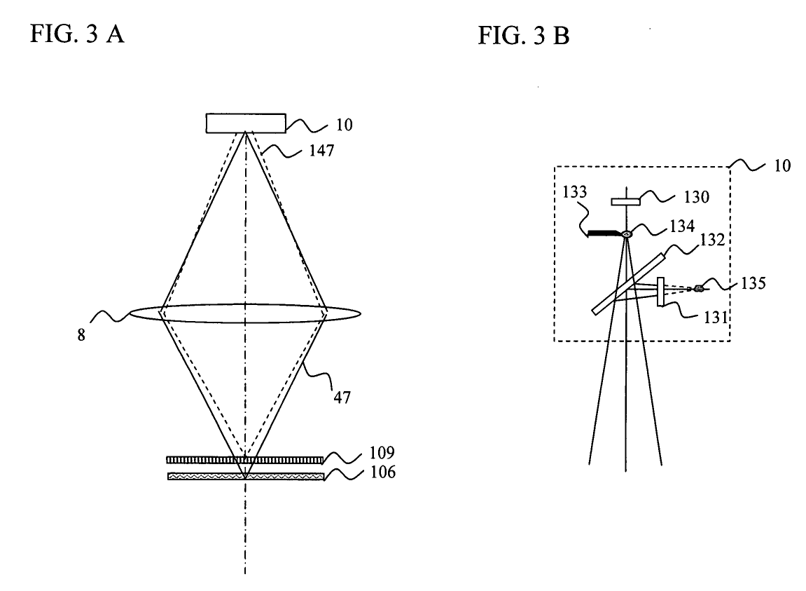

The reflected light flux 147 from the recording layer is irradiated via the objective lens 8 onto the optical detector 10 for receiving the light of the reflected light flux 147 from the servo layer as shown in FIG. 3A. An example of the structure of the optical detector 10 is shown in more detail in FIG. 3B. The reflected light flux from the multilayer disk is split into two light fluxes (rays) by the half-mirror 132. One light flux transmits (permeates) through the half-mirror 132 and is focused on the optimal focus point position 134. The knife edge 133 is installed on the focus point position 134. The shading light on the end of the knife edge 133 arrives at the split beam optical detector 130. When the spot on the disk surface deviates from the optimal focus point position, the convergence point of the light flux (or ray) moves upwards or downwards on the optical axis from the optimal focus point position 134, and half of the light flux is shaded by the knife edge, the distribution of transmitted (permeating) light varies according to whether the right half of the light flux transmits through or the left half of the light flux transmits through due to the front or rear of the focus point position 134. The split beam optical detector 130 detects this transmitted light as a focus error. This focus point detection method utilizing this type of optical detection system is called knife edge detection and is a well known method. The other light flux (or ray) is reflected by the half-mirror 132 and converged onto the optimal focus point position 135, however, the light intensity distribution of the light flux is detected by the split beam optical detector 131 installed along the path. A guide track is formed on the disk surface where the light spot converges and the split beam optical detector 131 detects the change in the distribution of the reflected diffractive light that varies according to the deviation of the light spot from the track center. The method for detecting the track error in this type of optical system is called the diffractive light track error detection method and is a well known method (See for example, Kenjiro Sakurai (editor) “Practical Laser Technology” IEEE, pp. 92-97.) Various methods are know for detecting focus errors and tracking errors however the structure of this invention can be applied to any of those methods.

The method of this invention for focusing the spot 107 of the light flux 147 from the semiconductor laser 115 on the desired recording layer, and recording and reproducing the information is hereafter described in detail.

### First Embodiment

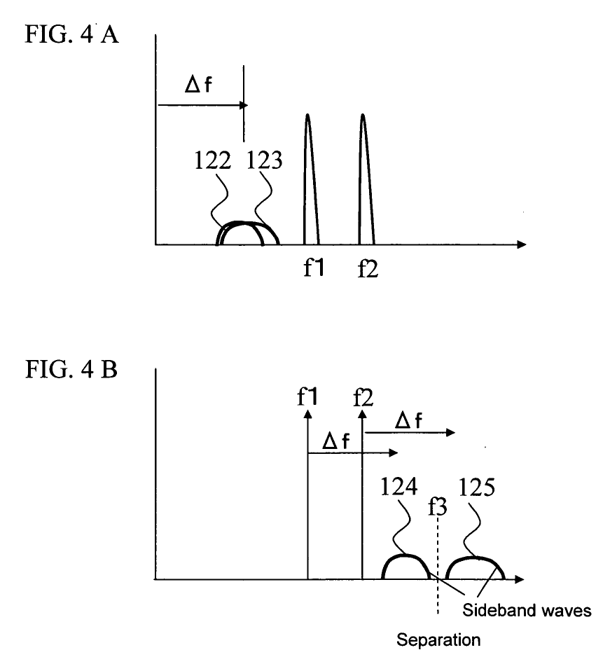

FIG. 4 is a concept drawing for describing the embodiment of the method of this invention for recording and reproducing onto the multilayer optical disk. As shown in FIG. 4A, the semiconductor laser 5 and the semiconductor laser 115 are each intensity-modulated by respectively different modulation frequencies f1 and f2. The signal spectrum recorded on the servo layer is reference numeral 122 and the signal spectrum recorded on the recording layer is reference numeral 123. The center of each signal spectrogram is positioned at Δf. When the semiconductor laser 5 spot is focused on the servo layer, and the semiconductor laser 115 spot is focused on the recording layer, the intensity of the light reflected from each layer is modulated by information on the servo layer or the recording layer, and as shown in FIG. 4B, the signal spectrogram of each layer are shifted to become the spectrograms 124, 125 just by an amount equal to Δf from the modulation frequencies f1, f2. The signal spectrogram 124 of the servo layer and the signal spectrogram 125 of the recording layer can therefore be separated by the cut-off frequency f3 filter.

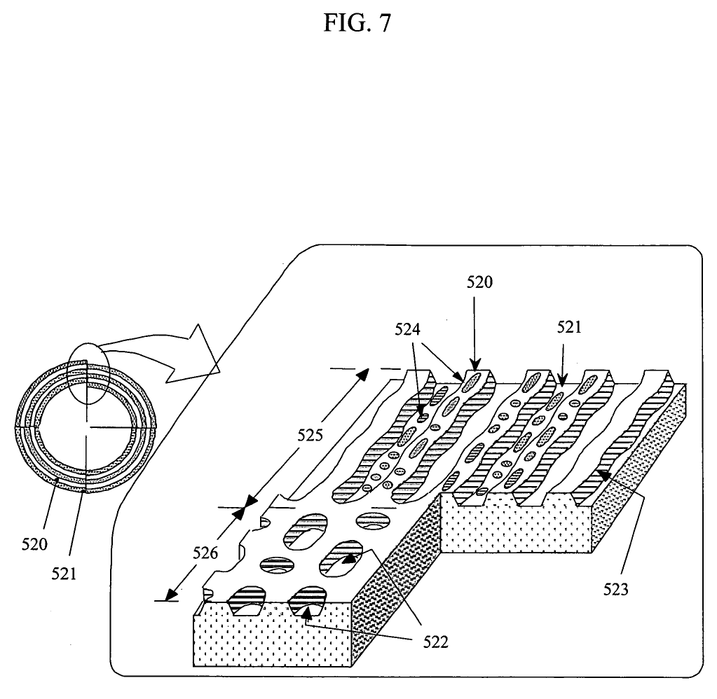

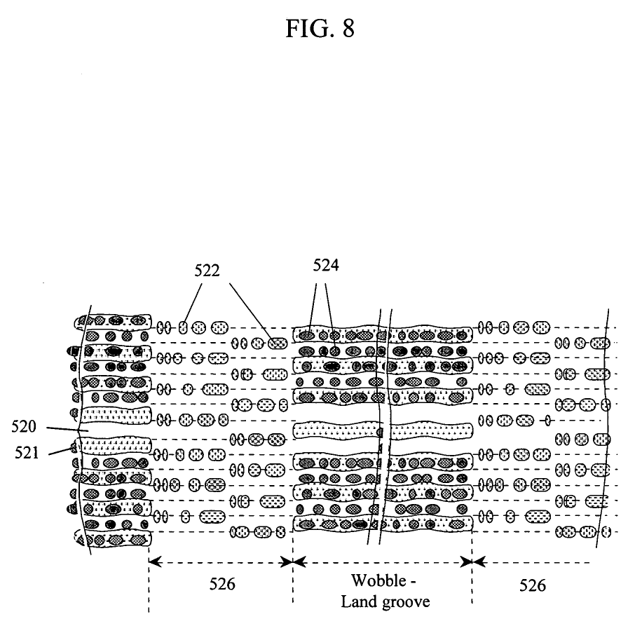

A DVD-RAM format can for example be used as the track layout for the servo layer (ECMA standards 272, 120 mm DVD Rewritable Disk (DVD-RAM). As shown in FIG. 7, the two states of the land 520 and the groove 521 mutually switch with every rotation of the track, and one rotation of the circumference is divided up into multiple sectors (units of mark-divided data) per one rotation. The sector is internally comprised of a header region 526 for entering control information for recording and reproducing (write and read) data such as address information, and user data region 525 for recording data. The recording marks 524 for expressing recording data for either of the land and groove sections can be recorded on the user data region 525. The land section makes tiny wobble movements radially along the track. These are called the wobble 523. The header region and the user data region are shown in more detail in FIG. 8. The emboss pits 522 of the header section are formed mutually offset from the track center on the boundary of the land section 520 and groove section 521 along the track radius. The address signals can in this way be detected whether in the land section or in the groove section. The user data is audio, video or data information utilized in computers or multimedia information comprised of a combination of this information, this user data is recorded in the user region.

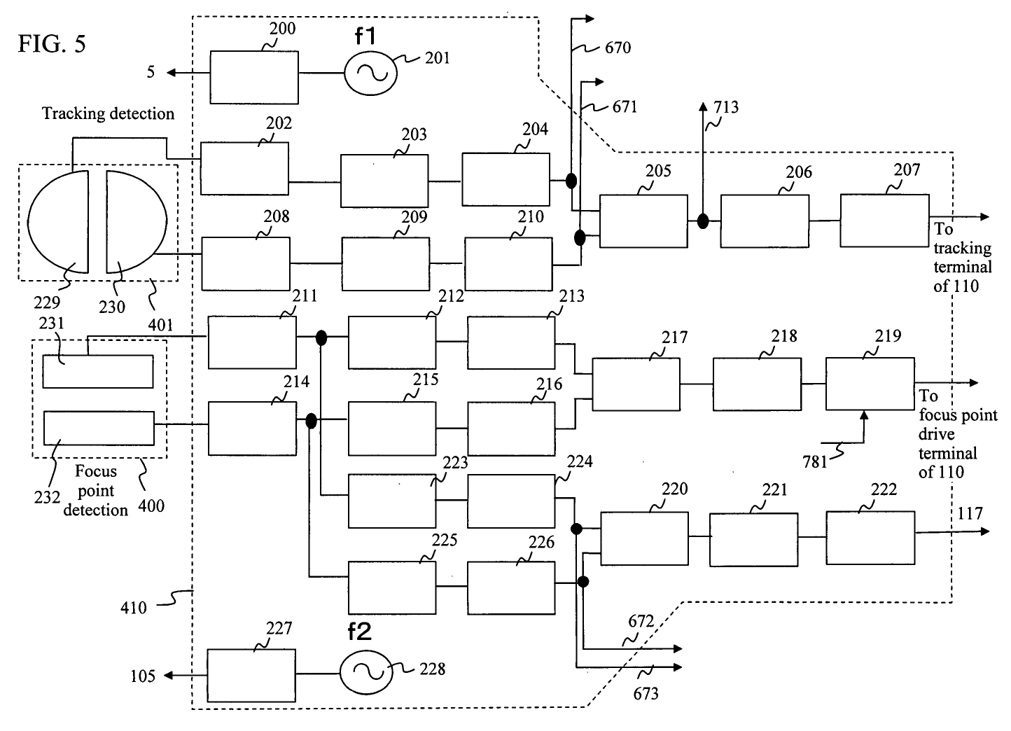

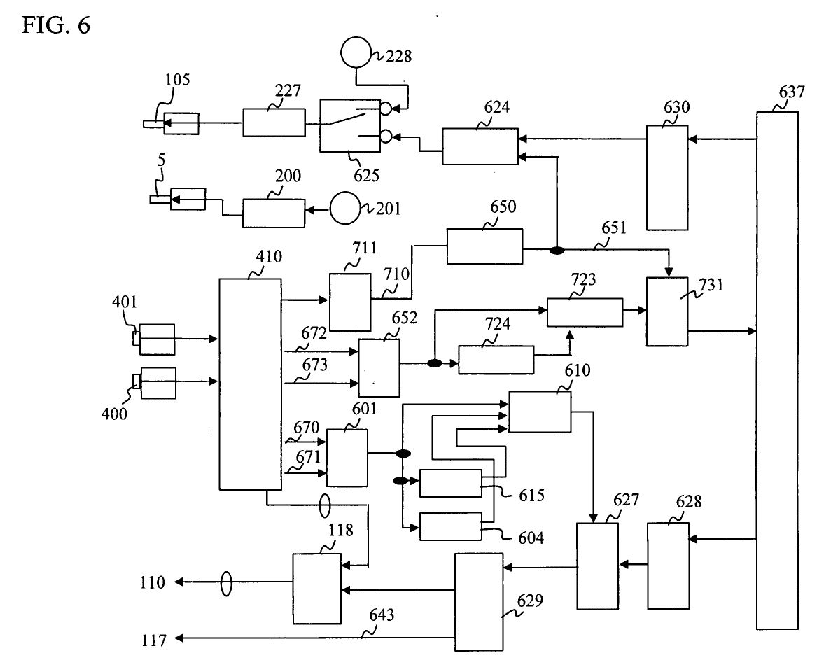

FIG. 5 is a detailed block diagram of the recording/reproduction circuit for the multilayer optical disk of this embodiment. FIG. 6 is a block diagram-of the overall multilayer optical disk of this embodiment. The operation of the recording/reproduction circuit of the multilayer optical disk of this embodiment is described while referring to FIG. 5 and FIG. 6.

The signal of frequency f1 generated from the oscillator 201 is input to the drive circuit 200, and modulates the intensity of the semiconductor laser 5. The signal of frequency f2 generated from the oscillator 228 on the other hand, is input to the drive circuit 227, and modulates the intensity of the semiconductor laser 105.

The method for slaving the spot 108 of semiconductor laser 5 to the track formed on the servo layer is first of all described. The reflected light from the recording layer and the servo layer is split for tracking signal detection and irradiated onto the detectors 229 and 230. The photo-electric current from the detectors 229 and 230 is input to the photoelectric converters 202, 208 and converted to a voltage. Their outputs (from 202 and 208) are passed through the cut-off frequency f3 low-pass filters 203, 209, the signal components of the signal spectrogram 124 are then passed, and the signal components of the signal spectrogram 125 are blocked. The output from the low-pass filters 203, 209 is input to the amplitude detectors 204, 210 and only the amplitude components are detected. The output from the amplitude detectors 204, 210 are input to the differential circuit 205, the balance of the light intensity irradiated onto and split by the detectors 229 and 230 for detecting the tracking signal is calculated, and tracking (deviations) errors of the spot 108 detected. More specifically, the output of the differential circuit 205 is input to the compensation circuit 206, the stability of the tracking control system is increased, that output is then input to the drive circuit 207, to a terminal of the two-dimensional actuator 110 to drive the objective lens 8 radially along the disk. The track error signal from the servo layer can in this way be detected without being affected by the information from the recording layer, and the spot 108 of semiconductor laser 5 can be slaved to the track on the servo layer.

The method for focusing the spot 108 from the semiconductor 5 on the servo layer is described next. The reflected light from the recording layer and servo layer is split and input to the detectors 231 and 232 for detecting the focus error signal. The photo-electric current from the detectors 231, 232 is input to the photoelectric converters 211,214 and converted to a voltage. The outputs (from the converters 211, 214) are passed through the low-pass filters 212 and 215 of the cut-off frequency f3, the signal component of the signal spectrum 124 is allowed to pass, and the signal component of the signal spectrum 125 is blocked. The output from the low-pass filters 212 and 215 is input to the amplitude detector circuits 213, 216 that detect only the amplitude component. The output from the amplitude detector circuits 213, 216 is input to the differential circuit 217, and the balance of the light intensity irradiated onto and split by the detectors 231 and 232 for detecting the focus error signal is calculated, and the spot 108 focus errors are detected. The output from the differential circuit 217 is input to the compensation circuit 218, and that output is then input to the drive circuit 219 to boost the stability of the focus control system, and is input to the terminal of the two-dimensional actuator 110 to drive the objective lens 8 along the z-direction of the optical axis. The focus error signal from the servo layer can in this way be detected without being affected by the information from the recording layer, and the spot 108 of semiconductor laser 5 can be slaved to the servo layer.

The method for focusing the information recording/reproducing spot 107 from the semiconductor laser 115 on the recording layer is described next. The photoelectric current from the detectors 231, 232 is input to the photoelectric converters 211, 214 and converted to a voltage. The outputs (from the converters 211, 214) are passed through the high-pass filters 223 and 225 of the cut-off frequency f3, the signal component of the signal spectrogram 125 created in the recording layer is allowed to pass, and the signal component of the signal spectrum 124 created in the servo layer is blocked. The output of the high-pass filters 223, 225 is input to the amplitude detectors 224, 226 that detect only the amplitude component. The output of the amplitude detectors 224, 226 is input to the differential circuit 220, and the balance of the light intensity for detecting the focus error signal and irradiated onto the detectors 231 and 232 is calculated, and the focus error of the spot 107 is detected. The output from the differential circuit 220 is input to the compensation circuit 221, and that output is then input to the drive circuit 222 to boost the stability of the focus control system, and drive the wedge glass plate 117 in a direction parallel to the optical path. The focus error signal from the recording layer can in this way be detected without being affected by the information from the servo layer, and the spot 107 can be slaved to the recording layer.

The output from the differential circuit 205 is input to the filter 711 in order to detect the wobbling signal 710 described later on. Also, the output signals 670, 671 from the amplitude detection circuits 204, 210 are input to the adder circuits 601 for generating the timing for recording and reproducing data such as the track address signal of the servo layer, and a signal indicating the total detected light intensity is formed. This signal is then supplied to the data discriminator (circuit) 610 and the area detection circuit 604. As shown in FIG. 7, the area detection circuit 604 detects a clock mark made up of a series of repetitive marks at a specific period from the header area 526. The area detection circuit 604 inputs this clock mark into a phase-locked loop (PLL) to generate a clock. Moreover, the area detection circuit 604 detects an address mark indicating the beginning of the address information, and inputs the address mark along with clock, into the data discriminator 610. The data discriminator 610 utilizes the address mark and the clock to reproduce the address information from the emboss bit following the address mark.

In the area detection circuit 604, the header area 526 is detected and identified from among the other areas, and a signal 66 showing the header area is input along with the clock signal to the data discriminator 610. The track address signal detected in the data discriminator 610 is input to the address comparator 627 and compared with the output from the register 628 for the address order from the host controller 637, and along with sending the control signal for the two-dimensional actuator 110 to the drive circuit 11 8 by using the circuit 629 to generate a signal for controlling the light spot, a signal 643 is sent for driving the wedge glass. The two-dimensional actuator (110) is driven towards the focus point, and the spot 108 is positioned on an optional block of the servo layer, from among N number of blocks, and the wedge glass is driven to position the spot 107 on the desired recording layer from among M number of recording layers within that block layer, to access the desired recording layer. To access the interior of the layer, the two-dimensional actuator 110 is moved along the track to position the spot 108 on the land or groove track using the address information 522 within the header area, as shown by the interior of the servo layer in FIG. 7. The track direction of the spot 107 is in this way linked to the spot 108 and positioned, and the focus point direction is shifted to a relative position by the movement of the wedge glass, using the servo layer as a reference.

The method for writing the data on the recording layer using the spot 107 from the semiconductor laser 115 is described next. The register 630 accepts the user data sent from the host controller 637 and stores it as recording information. Next, the recording information is input to the modulation circuit 624, and modulated by the output from the recording clock generating circuit 650, and the modulated signal is sent to the switching circuit 625. The output from the oscillator circuit 228 is supplied to the other input of the switching circuit 625. During recording, the modulated signal is input to the laser drive circuit 227, to intensity-modulate the light source 105, and the information recorded on the recording area of the recording layer, namely a position at the same circumference as the user data region 525 on the servo layer along the two-dimensional plane surface, and moreover perpendicularly on a region above and below the servo layer.

To reproduce data recorded on the recording layer, the spot 108 is positioned on a track on the servo layer, and the spot 107 is positioned on the desired recording layer, and the area where the information is recorded scanned. The reflected light is focused onto the optical sensors 130, 131 on the detector 10 to receive the light. The preamplifiers 202,208,211, 214 convert the photoelectric currents into a voltage, and control the two-dimensional actuator 110 based on information from the servo layer provided by the spot 108, and align the focus and perform tracking of the spot 108 on the servo layer. The drive circuits 222 drive the wedge glass 117 perpendicular to the optical path, and slave the spot 107 to the recording layer. Further, the output signals 672, 673 of the filters 224, 226 are input to the adder circuit 652 in order to reproduce the data on the recording layer, and a signal indicating the total detected light intensity is formed. This signal is input to the data discriminator 723 and clock generating circuit 724 (for reproduction). The data recorded on the recording layer is detected and demodulated according to the clock generated by the clock generating circuit 724 from the data discriminator 723, is stored in the register 731, and sent to the host controller 637. The data output from the data discriminator 723 is stored in the register 731 according to the clock signal 651. This data is converted to a user data format when sent to the host controller 637.

### Second Embodiment

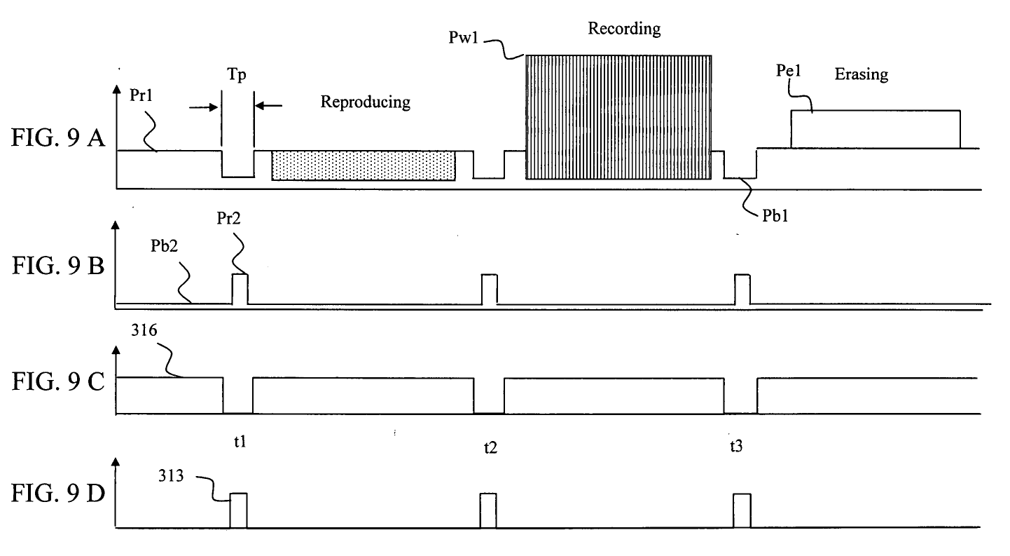

Another embodiment of this invention is described next. FIG. 9 is a drawing for describing the operating principle for recording and reproducing information onto the multilayer disk in this embodiment. The recording and reproducing operation in the recording layer is described in terms of the irradiation intensity of the semiconductor laser.

Light is irradiated at a read-out power level Pr1 onto the specified recording layer of the multilayer disk during information reproduction. During recording, the power level of the irradiated light is Pw1 which is larger than during read-out. A power level of Pe1 is required for erase on a rewritable medium, and as shown in FIG. 9A, the power level fluctuates greatly in each operation mode. In this embodiment, the signals from each layer are separated utilizing the same optical detector by shifting the timing for irradiating light onto the servo layer and the timing for irradiating the recording layer.

More specifically, as shown in FIG. 9A, data recording information is established in block units per the specified information value, and a pause interval Tp set between blocks. The power irradiated onto the recording layer during this period is set to a tiny level of Pb₁, and the power irradiated onto the servo layer is set as Pr2. Conversely, the power irradiated onto the servo layer during recording/reproducing of the recording layer is set to a tiny level of Pb2. By changing the emission timing for irradiation onto the recording layer and irradiation onto the servo layer, the signals can be split and detected in one detector without being subjected to respective effects.

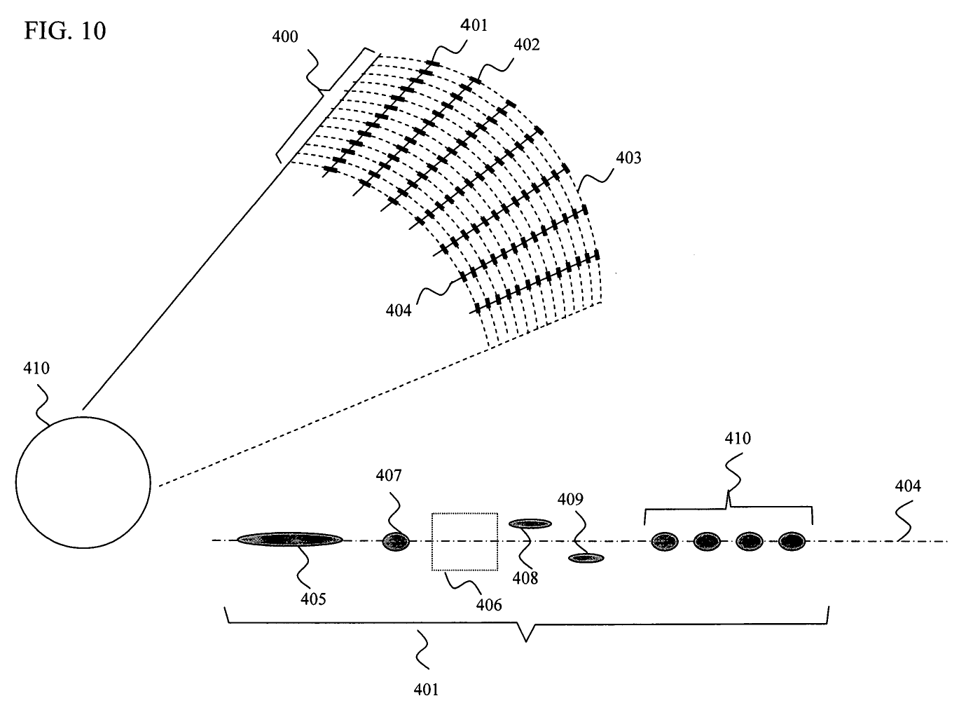

The structure of the servo track formed in the servo layer for implementing this embodiment is shown in FIG. 10. Multiple concentric circular tracks 403 are present from the inner radius (circumference) 410 of the disk to the outer radius. Control signal detection areas 401, 402 are located at equidistant intervals along the circumference of the track. A mark 405 for showing the beginning of the control area, followed by a clock mark 407 for generating a clock, and then followed by a focus error detection area 406 with no mark are contained to detect the focus error in this area, and followed by a pair of marks 408 and 409 offset to the left and right along the track radius and enclosing the track center 404. A specified number of tracks are established as the set 400, and the area 401 is arrayed in radial lines on the track. Next after the area 401 is the address mark group 410 for showing the address information. The sample servo for tracking by utilizing a pair of marks 408 and 409, as well as a clock mark 407 is already known (See U.S. Pat. No. 3,166,329, and Japanese Patent Publication No. 21879/1995). Except for the area containing the detection areas 401, 402 of the servo layer, the recording area of the recording layer is the same circumference along the two-dimensional plane surface, and also corresponds (to the same area) perpendicularly, above and below the servo layer.

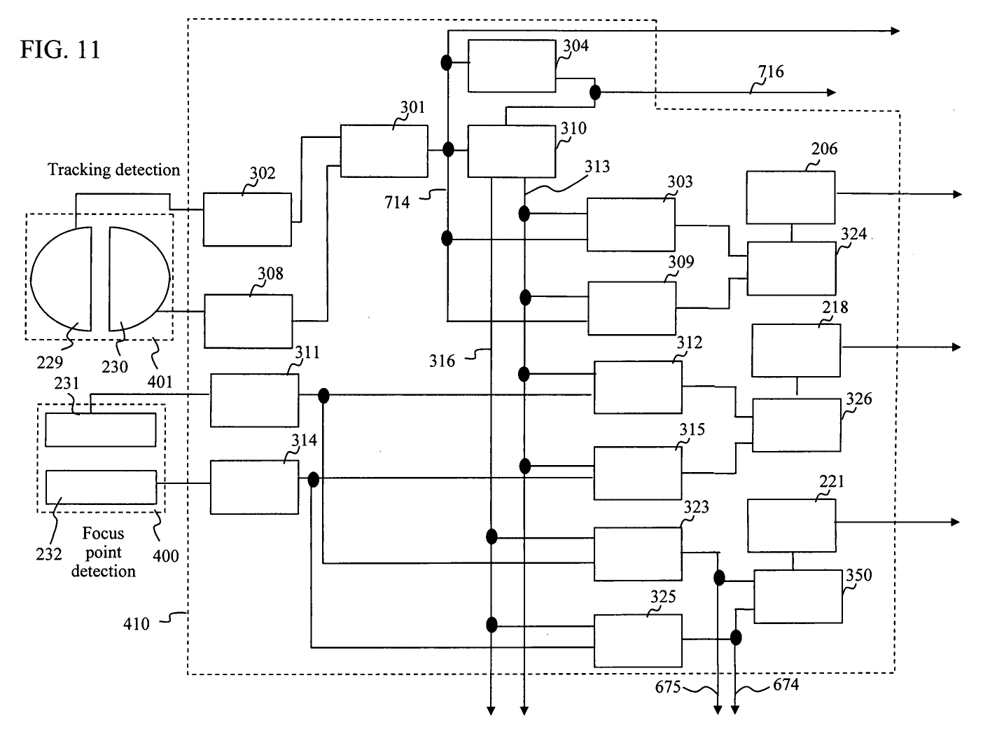

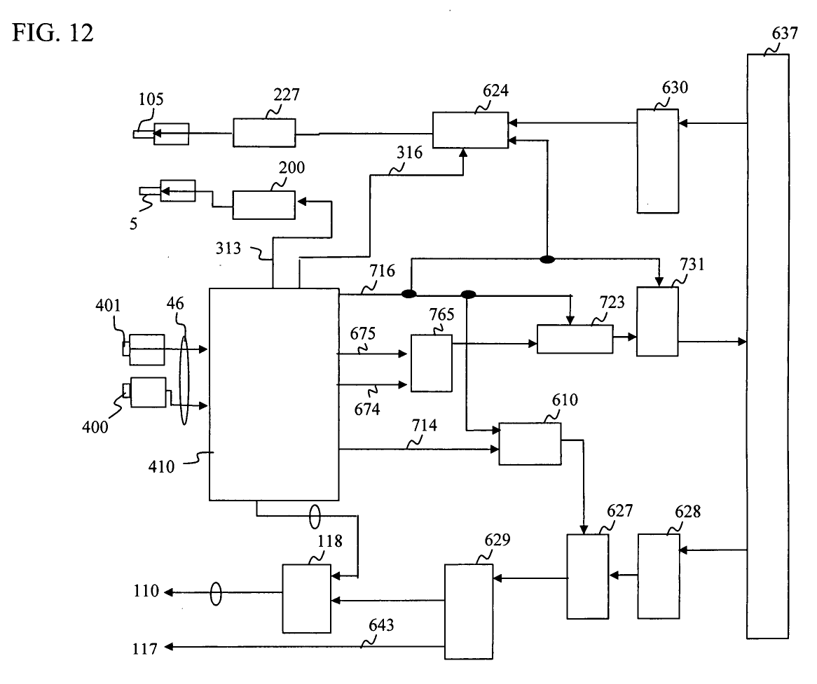

FIG. 11 is a detailed block diagram of a section of the recording/reproducing circuit system for the multilayer optical disk of this embodiment. FIG. 12 is a block diagram of the overall recording/reproduction circuit. The operation of the recording/reproducing circuit for the multilayer optical disk of this embodiment is described while referring to FIG. 11 and FIG. 12.

The photo-electric current received by the dual-split detectors 229 and 230 for detecting track error signals, is converted to a voltage by the photo-electric current detectors 302 and 308, and the output from the adder circuit 301 becomes the signal 714 for showing the total detected light intensity, and this signal is input to the clock generating circuit 304 and the timing generator circuit 310. In the initial operation, the spot from the disk run-out passes through the recording layer and the servo layer. In that process, the mark 405 is detected by the clock generator circuit 304 by utilizing the fact that the mark 405 is longer than marks in other control signal areas, and also marks showing information recorded in this information layer. Next, the focus error signal is sampled in the focus error detection region 406, a specified amount of time after the mark 405, the focus point controlled, and the spot positioned on the servo layer. The track error signal is then sample-detected by utilizing the track error detection marks 408, 409 after the mark 405, and tracking of the servo layer performed. The above operation is performed on the circuit level as follows.

The timing generator circuit 310 generates a sample logic signal 316 and 313 as shown in FIG. 9C and FIG. 9D. The clock generator circuit 304 recognizes the mark 405 indicating the beginning of the control area from the control area 401 as shown in FIG. 10, detects the timing generated by the clock marks 407 separated from the clock mark 405 by a specified distance, inputs that clock into a phase-locked loop (PLL), and generates the clock. A method well known for signal detection of the sample servo may be utilized as the method for generating this clock. The sample logic signals 316 and 313 are formed from the timing of this clock and the mark 405.

The signal 714 indicating the total detected light intensity is respectively input to the sample hold circuit 303 and 309. The signals from the mark 409 and the mark 408 of FIG. 10 are respectively detected in the sample hold circuits 303 and 309 by utilizing the sample logic signal 316, and their outputs supplied to the differential circuit 324, and by obtaining the difference between these signals, the deviation of the spot 108 from the track center 104 can then be detected. This track error signal is input to the compensation circuit 206, and that output is then input to a terminal of the two-dimensional actuator 110 to drive the objective lens 8 radially along the disk, and perform tracking.

The photoelectric current from the photodetectors 231, 232 is input to the photoelectric converters 311, 314, and after conversion to a voltage, that voltage is input to the sample hold circuits 312,315, 323,325. The sample hold circuits 312 and 315 detect only the reflected light from the servo layer emitted from the semiconductor laser 5 according to the sample logic signals 313. The differential between the outputs of the sample hold circuits 312 and 315 is obtained in the differential circuit 326, and the focus error (or deviation) between the servo layer and the spot 108 is detected. This focus error signal is input to the compensation circuit 218 the same as in FIG. 5, and that output is then input to the terminal of the two-dimensional actuator 110 to drive the objective lens 8 along direction z of the optical axis.

The sample hold circuits 323 and 325 utilize the sample logic signal 316 to sample and hold the output of the photoelectric converters 3 11 and 314, and detect only the reflected light from the recording layer emitted from the semiconductor laser 105. The differential between the outputs of the sample hold circuits 323 and 325 is obtained in the differential circuit 350, and the focus error (or deviation) between the servo layer and the spot 107 is detected. This focus error signal is input to the compensation circuit 221 the same as in FIG. 5, and is input to the terminal to drive the wedge glass 117 perpendicular to the optical axis, and align the focus on the desired recording layer from among M number of recording layers.

The operation of the recording and reproducing circuit is next described in even more detail while referring to FIG. 12. The signal 714 showing the total light intensity along with the clock signal 716 are both input to the data discriminator circuit 610. In the data discriminator circuit 610, the address signal is detected from the address mark 410 shown in FIG. 10, and the track address is reproduced. This reproduced track address signal is input to the address comparator 627 and compared with the output from the register 628 for the address order from the host controller 637, and along with sending the control signal for the two-dimensional actuator 110 to the drive circuit 118 by using the circuit 629 to generate a signal for controlling the light spot, a signal 643 is sent to drive the wedge glass. The two-dimensional actuator is driven towards the focus point, and the spot 108 is positioned on the servo layer of the desired block from among N number of blocks, and the wedge glass is driven to position the spot 107 on the desired recording layer from among M number of recording layers within that block layer, to access the desired recording layer. To access the layer, the two-dimensional actuator 110 is driven along the track by using the address information of the address mark group 410 in the servo layer shown in FIG. 10 and the spot 108 is positioned on the track. The spot 108 is in this way linked to the track direction of the spot 107 and positioned, and the focus point direction is shifted to a relative position by the movement of the wedge glass, using the servo layer as a reference.

The register 630 receives the user data sent from the host controller 637 and stores it as recording information. The recording information is next input to the modulation circuit 624, modulated by the clock 716, so that recording performed at the timing shown in FIG. 9A by means of the timing signal 316. During recording, the modulation signal is input to the laser drive circuit 227, the light source 105 is intensity-modulated, and the information recorded in the user data area 525 of the recording layer. During reproducing, a DC signal is input to the laser drive circuit, and the reflected light is modulated by the recording data in the data recording area as shown in FIG. 9A.

To reproduce data that was recorded on the recording layer, the spot 108 is positioned on a track on the servo layer, and the spot 107 is positioned on the desired recording layer, and placed on the area where the information is recorded, and the reflected light is focused onto the optical sensors 130, 131 to respectively receive the light. The photoelectric current is converted to a voltage in the preamps 302, 308, 311, and 314, and the servo information is detected. Moreover, the output signals 675, 674 of the sampling circuits 325, 323 are input to the adder circuit 765 for reproducing data on the recording layer, and a signal indicating the total detected light intensity is formed. This signal is then supplied to the data discriminator circuit 723. A clock signal 716 is input to the other input of the data discriminator circuit 723, the data information detected, demodulated, stored in the register 731, and sent to the host controller 637. The data output from the data discriminator 723 is stored in the register 731 according to the clock signal 716. This data is converted to a user data format when sent to the controller 637.

According to another aspect of the present invention, the following information recording/reproduction apparatus will be provided.

(1) An information recording/reproduction apparatus utilizing a multilayer optical disk formed from a combination of one servo layer and a plurality of recording layers, and comprising:

a first laser source;

a second laser source;

an optical system for combining the light flux from the first laser source and the light flux from the second laser source on one axis;

an objective lens for converging the combined light flux from the first laser source and the light flux from the second laser source on respectively different positions on the optical axis;

an actuator for driving the objective lens;

a optical detector including a focus error detector and a tracking error detector;

a timing generator circuit for generating a timing signal for alternately lighting up the first laser source and the second laser source based on a signal indicating the total detected light intensity;

a first focus point alignment section for driving the actuator along the optical axis based on the output of the focus error detector in the period that the first laser source is lit up;

a tracking controller for driving the actuator perpendicular to the optical axis based on the output of the tracking error detector in the period that the first laser source is lit up; and

a second focus point alignment section for driving the light flux spot from the second laser source along the optical axis based on the output from the focus point detector in the period that the second laser source is lit up.

(2) An information recording and reproducing apparatus according to (1), including a circuit for detecting a signal corresponding to the intensity of the light flux from the second laser source that interacted with one among the a plurality of recording layers, during the period that the second laser source is lit up; and a demodulator circuit for demodulating that detected signal.

(3). An information recording and reproducing apparatus according to (1), including a modulator circuit for modulating the recording information by utilizing a recording clock, and during the writing of information on the recording layer, the light flux from the second laser source is modulated by the modulator circuit output during the period that the second laser source is lit up.

(4) An information recording and reproducing apparatus according to (1), wherein the optical detector detects the light flux reflected from the multilayer optical disk via the objective lens.

(5) An information recording and reproducing apparatus according to (1), including a means for selecting the desired recording layer from the plurality of recording layers, as the recording layer for focusing the light flux from the second laser source.

(6) An information recording and reproducing apparatus according to (1), wherein the multilayer optical disk includes a plurality of sets each comprised from one servo layer and a plurality of recording layers; and a means for selecting the desired servo layer from a plurality of servo layers, as the servo layer for focusing the light flux from the first laser source.

What is claimed is:

1. An information recording and reproducing method utilizing a multilayer optical disk made up of sets combining one servo layer and a plurality of recording layers, and said method comprising:
a process for irradiating a first laser beam intensity-modulated by a first frequency, and a second laser beam intensity-modulated by a second frequency onto the multilayer optical disk along the optical axis of an objective lens, and converging the first laser beam and the second laser beam onto respectively different positions on the optical axis;
a process utilizing an optical detector for detecting the first laser beam and the second laser beam mutually interacting with the multilayer optical disk;
a process for deriving the tracking error signal and the focus error signal from the signal component caused by the first laser beam interacting with the servo layer, and acquired by frequency separation of the output from the optical detector;
a process for controlling the objective lens position versus the multilayer optical disk by utilizing the tracking error signal and the focus error signal, and slave the first laser beam spot to the desired track on the servo layer;
a process for deriving the focus error signal of the second laser beam on the recording layer from the signal component caused by the second laser beam interacting with one of the a plurality of recording layers obtained by frequency separation of the output of the optical detector; and
a process for aligning the focus point of the second laser beam spot on the recording layer by utilizing the focus error signal of the second laser beam.

2. An information recording and reproducing method according to claim 1 comprising: a process for deriving the signal component corresponding to the intensity of the second laser beam that interacted with the recording layer; and a process for demodulating the signal component corresponding to the intensity of the second laser beam and generating a reproducing signal.

3. An information recording and reproducing method according to claim 1, comprising a process for modulating the second laser beam with the recording information instead of intensity modulation with the second frequency, and recording information on the recording layer.

4. An information recording and reproducing apparatus utilizing a multilayer optical disk made up of sets combining one servo layer and a plurality of recording layers, with the apparatus comprising:
a first laser source;
a second laser source;
a first oscillator for intensity-modulating the light flux from the first laser source with a first frequency;
a second oscillator for intensity-modulating the light flux from the second laser source with a second frequency;
an optical system for combining the light flux from the first laser source and the light flux from the second laser source on one axis;
an objective lens for converging the combined light flux from the first laser source and the light flux from the second laser source on respectively different positions on the optical axis;
an actuator for driving the objective lens;
an optical detector including a focus error detector and a tracking error detector;
a first frequency filter for separating the signal components output from the optical detector caused by the laser beam intensity-modulated by the first frequency and that interacted with the servo layer;
a second frequency filter for separating the signal components output from the optical detector caused by the intensity-modulation of the laser beam by a second frequency that interacted with the recording layer;
a first focus point alignment section for driving the actuator along the optical axis based on the output of the focus error detector output that was separated by the first frequency filter;
a tracking controller for driving the actuator perpendicular to the optical axis based on the output from the tracking error detector separated by the first frequency filter; and
a second focus point alignment section for driving the light flux spot from the second laser source along the optical axis based on the focus point detector output separated by the second frequency filter.

5. An information recording and reproducing apparatus according to claim 4, comprising a circuit for detecting a signal corresponding to the intensity of the light flux from the second laser source that interacted with one among the a plurality of recording layers, after the signal component was separated by the second frequency filter; and a demodulator circuit for demodulating that detected signal.

6. An information recording and reproducing apparatus according to claim 4,, including a modulator circuit for modulating the recording information by using a recording clock; and a switching circuit for switching to the second oscillator and the modulator circuit, wherein the output from the modulator circuit modifies the light flux from the second laser source when writing information onto the recording layer.

7. An information recording and reproducing apparatus according to claim 4, wherein the optical detector detects the light flux reflected from the multilayer optical disk via the objective lens.

8. An information recording and reproducing apparatus according to claim 4, including a means for selecting the desired recording layer from the plurality of recording layers, as the recording layer for focusing the light flux from the second laser source.

9. An information recording and reproducing apparatus according to claim 4, wherein the multilayer optical disk includes a plurality of sets each comprised from one servo layer and a plurality of recording layers; and a means for selecting the desired servo layer from a plurality of servo layers, as the servo layer for focusing the light flux from the first laser source.

10. An information recording and reproducing method utilizing a multilayer optical disk made up of a set combining one servo layer and a plurality of recording layers, and said method comprising:
a process for irradiating a first laser beam, and a second laser beam onto the multilayer optical disk along the optical axis of one objective lens, and converging the first laser beam and the second laser beam onto respectively different positions on the optical axis;
a process for detecting the first laser beam that interacted with the servo layer;
a process for generating a sample logic signal from the first laser beam detection output signal;
a process for alternately lighting up the first laser beam and the second laser beam according to the sample logic signal;
a process for deriving the tracking error signal and the focus error signal for the servo layer in the period that the first laser beam is lit up;
a process for controlling the position of the objective lens versus the multilayer optical disk by utilizing the tracking error signal and the focus error signal, and slave the first laser beam spot to the desired track on the servo layer;
a process for detecting the second laser beam interacting with one among the a plurality of recording layers, during the period that the second laser beam is lit up, and deriving the focus error signal of the second laser beam versus the recording layer; and
a process for aligning the focus point of the second laser beam spot on the recording layer by utilizing the focus error signal of the second laser beam.

11. An information recording and reproducing apparatus according to claim 10, wherein during the period that the second laser beam is lit up, a signal is detected corresponding to the intensity of the second laser beam that interacted with the recording layer, and that signal is demodulated and a reproducing signal is formed.

12. An information recording and reproducing apparatus according to claim 10, wherein the second laser beam is modulated by the recording information and information is written on the recording layer during the period that the second laser beam is lit up.

13. An information recording and reproducing apparatus according to claim 10, wherein the optical detector detects the light flux reflected from the multilayer optical disk via the objective lens.

14. An information recording and reproducing apparatus according to claim 10, wherein the multilayer optical disk includes a plurality of sets each comprised from one servo layer and a plurality of recording layers; and a means for selecting the desired servo layer from a plurality of servo layers, as the servo layer for focusing the light flux from the first laser source.
